(19) United States
(12) Patent Application Publication
(10) Pub. No.: US 2026/0014829 A1
(43) Pub. Date: Jan. 15, 2026

(54) Air Conditioner and Vehicle With Such an Air Conditioner

(71) Applicant: MAHLE International GmbH, Stuttgart (DE)

(72) Inventors: Matthias Schall, Ostfildern-Ruit (DE); Kerstin Wochele, Friolzheim (DE)

(21) Appl. No.: 19/268,004

(22) Filed: Jul. 14, 2025

(30) Foreign Application Priority Data
Jul. 15, 2024 (DE) 102024120025.1

(51) Int. Cl. B60H 1/00

(52) U.S. Cl. CPC B60H 1/00328

(57) ABSTRACT

An air conditioner for a vehicle, which has a modular assembly with numerous conditioning units for an airflow entering the passenger compartment in the vehicle is provided The air conditioning units, which contain a heat recovery module in particular, are arranged in a sequence and formed by modules that can be mechanically connected directly to one another for fluid exchange. A vehicle that has a passenger compartment and such an air conditioner, the conditioning units of which are designed to condition the airflow entering the passenger compartment is also provided.

### CROSS-REFERENCE TO RELATED APPLICATIONS

This application claims priority from German Patent Application No. DE 10 2024 120 025.1, filed on Jul. 15, 2024, the entirety of which is hereby incorporated by reference herein.

The present invention relates to an air conditioner for a vehicle, in particular a vehicle with an internal combustion engine, or an electric vehicle, which has a modular assembly with numerous conditioning units for conditioning an airflow entering the passenger compartment in the vehicle. The invention also relates to a vehicle that has such an air conditioner.

DE 10 2020 109 904 A1 discloses an air conditioner of this type. It is used in a vehicle to condition the airflow entering the passenger compartment in a vehicle. The conditioning of the airflow normally comprises controlling the temperature by a user, and filtering to remove undesired substances such as particles, gases and odors from the airflow.

For economic reasons, it is desirable to be able to use the air conditioner in numerous vehicle models within a vehicle platform. This means it should be able to be used for numerous different types of vehicles. Because there may be substantial differences from one type of vehicle to another, in particular with respect to the available installation space for the air conditioner, as well as the specifications, it must be possible to inexpensively adapt the air conditioner to the various installation situations and specifications.

Based on this, the object of the present invention is to create an improved, or at least different, design for an air conditioner. In particular, an air conditioner is to be obtained that can be adapted to new types of vehicles. Another object of the invention is to obtain an advantageous vehicle that has such an air conditioner.

This object is achieved with the present invention by the subject matter of the independent claims. Advantageous embodiments are the subject matter of the dependent claims, description, and drawings.

The invention realizes that the first object can be achieved with the features of the air conditioner for a vehicle specified above, in that the conditioning units in the air conditioner are lined up in a sequence and form modules that can be or are mechanically connected to one another in an arbitrary order for fluid exchange.

Consequently, the positions of the modules within the assembly can be altered, such that the modular assembly can be adapted to new types of vehicles. The number of modules can also be increased by adding at least one more module to the assembly, or reduced by omitting one of the modules. The air conditioner can be inexpensively adapted to those types of vehicles in which one or more of the modules in the air conditioner are placed in the passenger compartment and one or more of the modules are placed in a spaced in the front of the vehicle, in particular in the engine compartment, e.g. in an electric vehicle.

The expression, “conditioning an airflow,” is understood to mean “adjusting an airflow,” in particular in the sense of altering one or more properties of the airflow, in particular its temperature, the quantity of undesired substances (e.g. particles, gases, and odors), or its humidity, etc. according to the desires of a user. Furthermore, the term, “direct,” as it is used herein, indicates that the modules can be connected to one another such that they come in contact with one another. This means that connectors and adapters are ideally unnecessary for connecting adjacent modules. Furthermore, the airflow can come from outside the vehicle, inside the vehicle, or from both outside and inside the vehicle. Furthermore, it is clear that this airflow may contain undesired particles, gases, and odors prior to passing through the air conditioner.

It should also be noted that the “sequence” in which the modules are placed can be straight or curved. In other words, the conditioning units can either be placed in a straight line, or along a curve.

One of the modules in the assembly can be a heat recovery module with which heat from an exhaust airflow that is to be removed from the passenger compartment in the vehicle can be transferred to the airflow. This results in a modular heat recovery module that can be placed practically anywhere within the modular assembly for the air conditioner. Ideally, the heat recovery module is upstream of a vaporizing module and a heater module. By way of example, the heat recovery module in an air conditioner that has modules in both the front of the vehicle, in particular in the engine compartment, and in the passenger compartment in the vehicle, can be placed in either this motor engine compartment, or the passenger compartment. By using the heat recovery module, the efficiency of the air conditioner with regard to energy consumption can be improved because heat in the exhaust airflow is not simply discarded into the environment, but instead is transferred to the airflow, and thus recovered.

The heat recovery module is preferably an air-to-air heat exchanger. Preferably, the exhaust airflow that exits the passenger compartment is separated from the airflow within the heat recovery module, and the two airflows cross over one another in passing.

The modules can also contain internal channel segments, which form a channel for the modular assembly in the assembled state, through which a path for the airflow passes. The modules each have an intake side with an intake hole for a channel segment in the respective module, and an outlet side with an outlet hole for a channel segment in the respective module. The intake holes and outlet holes in adjacent modules are ideally identical, or substantially identical. This has advantages with regard to the airflow, because adjacent modules can then be coupled directly to one another in a row, without the need for connectors or adapters to compensate for holes of different sizes in the channel segments. Eliminating the connectors results in a more compact and lighter air conditioner, which has advantages when used in limited installation spaces. Eliminating connectors also prevents undesired pressure drops within the fresh air channels. This has a positive effect on the acoustics and/or amount of air that can be conveyed. The geometric dimensions of the intake holes and outlet holes, and/or the shapes of the intake holes and outlet holes may be identical, or substantially identical. The intake holes and outlet holes may also have cross section areas of the same, or substantially the same, size and/or shape. In other words, the intake holes and outlet holes for the channel segments have identical, or substantially identical, cross sections. The meaning of the expression, “substantially identical,” in the scope of the invention, refers to production tolerances, thus indicating that these intake and outlet holes are identical, “within the scope of typical production tolerances.”

The modules can also have internal channel segments that form a channel for the airflow when the modular assembly has been assembled. Each of the modules has an intake side with a first mechanical interface for connecting it to an adjacent module, and an outlet side with a second mechanical interface for connecting it to an adjacent module. The first and second mechanical interfaces are complementary, with connecting structures can that can be coupled to one another. In other words, the modules in the assembly have uniform first and second complementary mechanical interfaces. Consequently, the modules can be mechanically coupled directly to one another in an arbitrary sequence. This has the advantage that different embodiments of the air conditioner can be easily obtained, such that it can be adapted quickly and inexpensively to new vehicle models. At least one of the first and/or second mechanical interfaces may be designed such that it can be mechanically connected to a vehicle body, e.g. at a separating wall in the structure of the body. Consequently, one or more modules can be permanently attached to the vehicle body, e.g. at a separating wall.

The connecting structures on the first mechanical interfaces can be grooves, and the connecting structures on the second mechanical interfaces can be tongues.

Alternatively, the connecting structures on the second mechanical interfaces can be grooves, and the connecting structures on the first mechanical interfaces can be tongues. It is clear to the person skilled in the art that “tongues” are protrusions that fit into the grooves. These allow the modules to be easily coupled directly to one another in an arbitrary sequence by simply fitting the tongues into the grooves when assembling the modular assembly for the air conditioner. The first and second mechanical interfaces can also have other complementary snap-together elements, which may or may not be releasable, to obtain force-and/or form-fitting connections, with which adjacent modules can be connected to one another. The interfaces could also be glued or welded together while assembling the modular assembly.

In particular, the modular assembly can contain at least one of the following modules: a filter module for the airflow, a vaporizer module for cooling the airflow, a distributor module for distributing the airflow in the passenger compartment, a fresh air/recirculated air module for introducing fresh air from outside the vehicle or recirculating air from inside the passenger compartment, or mixing fresh air with recirculated air, and a fan module for conveying the airflow. The distributor module can contain at least one heater with which the airflow can also be heated. There can also be a fan in the fresh air/recirculated air module with which fresh air, recirculated air, or a mixture thereof is suctioned off from the environment or the passenger compartment. These are the different modules for the air conditioner that are designed to condition the airflow. Each module can be provided by a distributer separately, such that the air conditioner is produced on site to a certain extent.

In particular, the modules can be arranged in one of the following sequences:
1) The fresh air/recirculated air module with an, or the, integrated fan, the filter module, the heat recovery module, the vaporizer module, and the distributor module with an, or the integrated heater.
2) The filter module, the fresh air/recirculated air module with an, or the, integrated fan, the heat recovery module, the vaporizer module, and the distributor module with at least one, or the, integrated heater.
3) The fresh air/recirculated air module with an, or the, integrated fan, the heat recovery module, the filter module, the vaporizer module, and the distributor module with at least one, or the, integrated heater.
4) A fresh air/recirculated air module without a fan, the fan module, the filter module, the heat recovery module, the vaporizer module, and the distributor module with at least one, or the, integrated heater. In this case, the fan module is upstream of the vaporizer module.
5) The fresh air/recirculated air module, the filter module, the heat recovery module, the vaporizer module, the fan module, and the distributor module with at least one, or the, integrated heater. In this case, the fan is downstream of the vaporizer module.

These are preferred assemblies, and preferred sequences for the modules in the assembly. They can be advantageously used with different types of vehicles, in particular electric vehicles. The heat recovery module can consequently be advantageously integrated in the modular assembly. Fundamentally, the modular assembly does not need to have a heat recovery module. It should be mentioned that the position of the filter module within the modular assembly is arbitrary. It may be advantageous, however, to place the filter module upstream of the vaporizer, a heater, and the heat recovery module.

The second object of the invention is achieved with a vehicle that has a passenger compartment and an air conditioner according to the description above, in which conditioning units in the air conditioner are designed to condition the airflow supplied to the passenger compartment.

The heat recovery module in the air conditioner's modular assembly may be placed inside the passenger compartment. It could also be placed in another compartment, e.g. the engine compartment at the front of the vehicle. The first embodiment has the advantage that the air in the passenger compartment can be supplied directly to the heat recovery module. This does not require separate air channels, resulting in a compact and lightweight vehicle, or air conditioner.

The heat recovery module can have an exhaust channel opening into the exterior for the exhaust air from the passenger compartment supplied thereto, such that the exhaust air can be discharged into the environment through the exhaust channel after passing through the heat recovery module. The second embodiment can be used advantageously in electric vehicles, leaving a lot of space in the passenger compartment when the heat recovery module is placed in the front of the vehicle, in particular in the engine compartment. As mentioned above, the heat recovery module can be placed upstream of the vaporizer module for functional reasons.

In a vehicle with an internal combustion engine, it may be advantageous for the modular assembly to contain the following modules: the fresh air/recirculated air module with an integrated fan, the filter module, the heat recovery module, the vaporizer module, and the distributor module with at least one, or the, integrated heater. An advantageous modular assembly is obtained when all of these modules are inside the passenger compartment. Alternatively, the fresh air/recirculated air module with an, or the, integrated fan, and the filter module can be placed in the front of the vehicle, in particular in the engine compartment, while the heat recovery module, vaporizer module, and distributor module with at least one, or the, integrated heater are placed in the passenger compartment. This results in a relatively large number of modules in the passenger compartment, leaving more space in the front of the vehicle, in particular the engine compartment, e.g. for internal combustion engine components.

With an electric vehicle, it may be advantageous for the modular assembly to contain the following modules: the fresh air/recirculated air module with an, or the, integrated fan, the filter module, the heat recovery module, the vaporizer module, and the distributor module with at least one, or the, integrated heater. The fresh air/recirculated air module with an, or the, integrated fan, the filter module, and the heat recovery module may be placed in the front of the vehicle, in particular the engine compartment, while the vaporizer module and distributor module with at least one, or the, integrated fan can be placed in the passenger compartment. The fresh air/recirculated air module with an, or the, integrated fan, the filter module, the heat recovering module, and the vaporizer module could also be placed in the front of the vehicle, in particular the engine compartment, with only the distributor module with at least one, or the, integrated fan being place in the passenger compartment. In this case, a relatively large number of modules are placed in the front of the vehicle, such that fewer modules are in the passenger compartment, resulting in more space therein.

The modular assembly in the air conditioner may also contain a heat recovery module and a vaporizer module that has a condensation channel for removing condensation from the vaporizer module, and the heat recovery module can have an exhaust channel for removing exhaust air from the passenger compartment. This condensation channel and exhaust channel can be joined together to form a collective discharge channel in order to remove both condensation and exhaust air. The discharge channel can contain two separate ducts, the first of which is for condensation, and the second is for exhaust air. Alternatively, the discharge channel may contain just one duct into which both the condensation and the exhaust air are conducted. This discharge channel can be incorporated in a separating wall or the floor of the vehicle. This has the advantage that penetrations in the separating wall between the front of the vehicle and the passenger compartment, or the floor, can be used for the discharge channel, i.e. the condensation channel and exhaust channel. In this case, an existing penetration for the condensation channel in a separating wall or the floor can be expanded to the size of the exhaust channel. There is no need for separate penetrations for the condensation channel and discharge channel. The condensation channel and/or exhaust channel and/or collective discharge channel can pass through the floor of the vehicle to the exterior.

In an alternative embodiment, the condensation channel and exhaust channel can be separate channels, at least in part. Consequently, the exhaust air and the condensation can be removed separately from the vehicle. In another embodiment, the condensation channel and the exhaust channel can be joined to form a collective discharge channel with a T-shaped or Y-shaped element.

Other important features and advantages of the invention can be derived from the dependent claims, drawings, and descriptions of the drawings.

It is understood that the features specified above and described below can be used not only in the given combinations, but also in other combinations or in and of themselves, without abandoning the scope of the present invention. Components of a higher order unit specified herein, e.g. an apparatus, device or assembly, that are indicated separately, can form separate components of this unit, or be integral parts or sections of this unit, even if otherwise indicated in the drawings.

Preferred exemplary embodiments of the invention are shown in the drawings and shall be explained in greater detail below, in which the same reference symbols are used for identical, similar, or functionally identical components.

Therein, schematically:

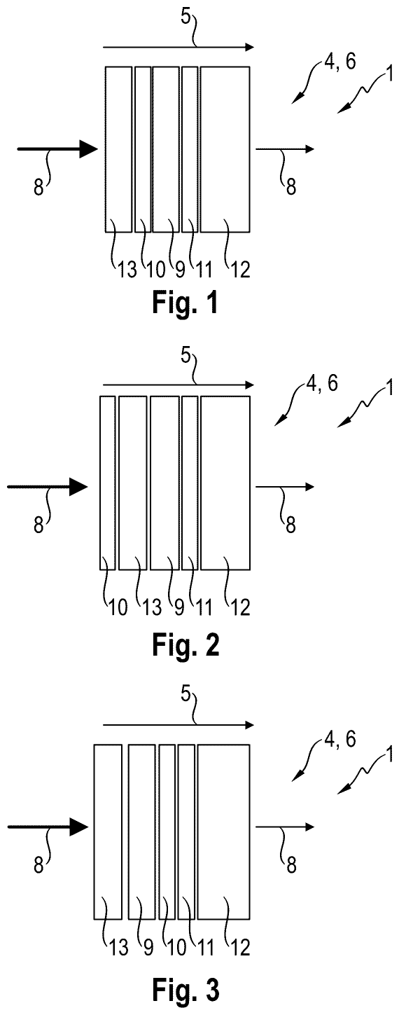

FIGS. 1 to 5 show various embodiments of the air conditioner obtained with the invention,

FIG. 6 shows an embodiment of the air conditioner obtained with the invention, with a heat recovery module,

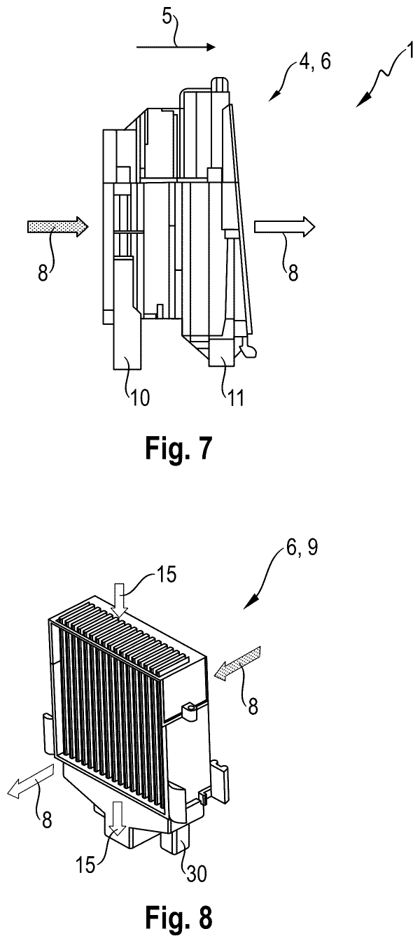

FIG. 7 shows an embodiment of the air conditioner obtained with the invention without a heat recovery module,

FIG. 8 shows a perspective view of a heat recovery module for the air conditioner obtained with the invention,

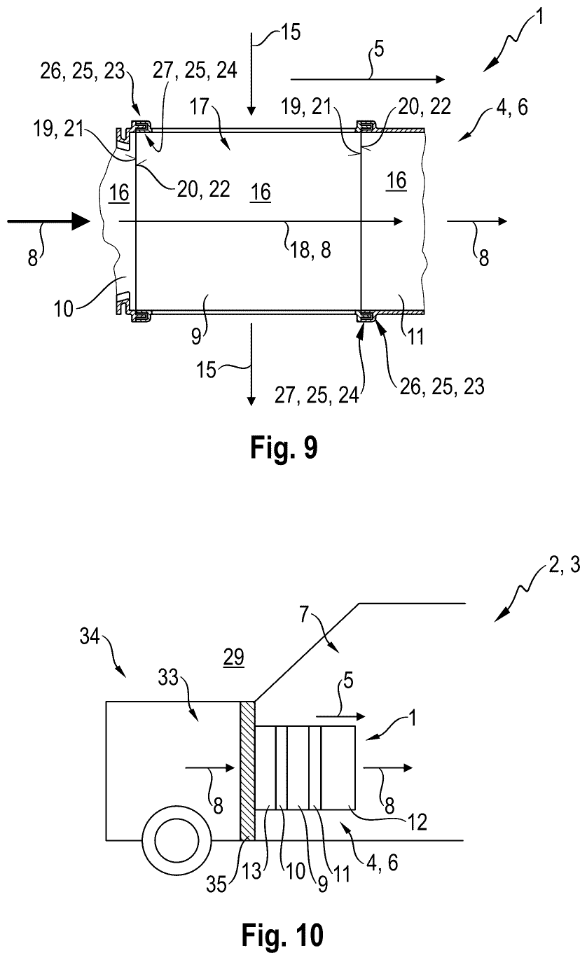

FIG. 9 shows a highly simplified cutaway view of the modular assembly for the air conditioner obtained with the invention, and

FIGS. 10 to 13 each show a vehicle obtained with the invention, which has a preferred embodiment of an air conditioner obtained with the invention.

FIGS. 1 to 5 show various embodiments of the air conditioner 1. The air conditioner 1 is intended for a vehicle 2, 3 shown in FIGS. 10 to 13, in particular a vehicle 2 with an internal combustion engine, or an electric vehicle 3, and is designed to condition an airflow 8 supplied to a passenger compartment 7 in the vehicle 2, 3. The conditioning of the airflow 8 comprises adjusting the temperature thereof according to a user's preference, and filtering undesired substances therefrom, e.g. particles, gases, and odors. The airflow 8 is formed by fresh air from the exterior 29 indicated in FIGS. 10 to 13, recirculated air from the passenger compartment 7, or a mixture thereof. This airflow 8 may contain undesired particles, gases, and odors prior to passing through the air conditioner 1.

The air conditioner 1 contains a modular assembly 4 composed of numerous conditioning units 6 arranged in a sequence 5 indicated by an arrow. The conditioning units 6 are designed to condition the airflow 8. To be able to adapt the modular assembly 4, or air conditioner 1, to new vehicle models, the conditioning units 6 can form modules 9, 10, 11, 12, 13, 14 that can be mechanically connected directly to one another for fluid exchange in an arbitrary sequence 5.

In the embodiment of the air conditioner 1 obtained with the invention shown in FIG. 1, the modular assembly 4 contains the following modules 9, 10, 11, 12, 13, which are mechanically connected to one another for fluid exchange in the following sequence 5: a fresh air/recirculated air module 13 with an integrated fan for suctioning off fresh air from the exterior, the passenger compartment 7, or a mixture thereof, a filter module 10 for filtering the airflow 8, a heat recovery module 9 for transferring heat from exhaust air 15 that is to be discharged from the passenger compartment 7 in the vehicle 2, 3, to the airflow 8, a vaporizer module 11 for cooling the airflow 8, and a distributor module 12 with an integrated heater that is designed to distribute the airflow 8 in the passenger compartment 7 in the vehicle 2, 3, and to heat the airflow 8.

In the embodiment of the air conditioner 1 obtained with the invention shown in FIG. 2, the modular assembly 4 contains the following modules 9, 10, 11, 12, 13, which are mechanically connected to one another for fluid exchange in the following sequence 5: the filter module 10, the fresh air/recirculated air module 13 with an integrated fan, the heat recovery module 9, the vaporizer module 11, and the distributor module 12 with at least one integrated heater.

In the embodiment of the air conditioner 1 obtained with the invention shown in FIG. 3, the modular assembly 4 contains the following modules 9, 10, 11, 12, 13, which are mechanically connected to one another for fluid exchange in the following sequence 5: the fresh air/recirculated air module 13 with an integrated fan, the heat recovery module 9, the filter module 10, the vaporizer module 11, and the distributor module 12 with at least one integrated heater.

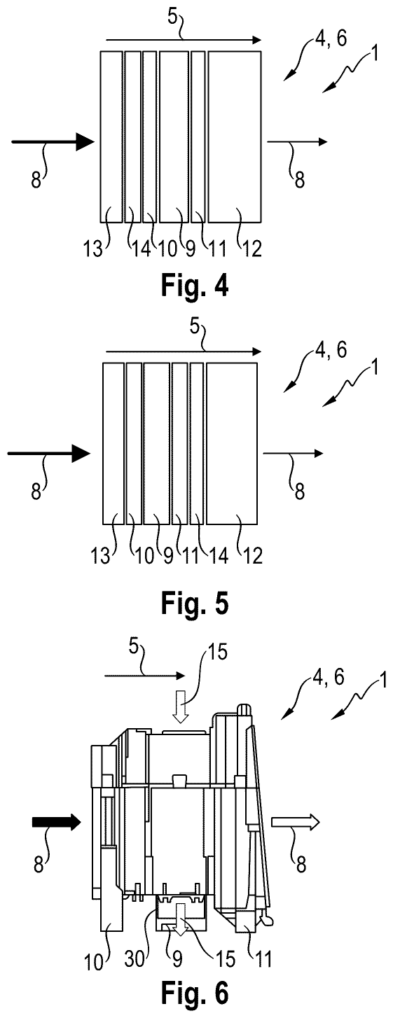

In the embodiment of the air conditioner 1 obtained with the invention shown in FIG. 4, the modular assembly 4 contains the following modules 9, 10, 11, 12, 13, 14, which are mechanically connected to one another for fluid exchange in the following sequence 5: the fresh air/recirculated air module 13 without a fan, a fan module 14 for conveying the airflow 8, the filter module 10, the heat recovery module 9, the vaporizer module 11, and the distributor module 12 with at least one integrated heater.

In the embodiment of the air conditioner 1 obtained with the invention shown in FIG. 5, the modular assembly 4 contains the following modules 9, 10, 11, 12, 13, 14, which are mechanically connected to one another for fluid exchange in the following sequence 5: the fresh air/recirculated air module 13 without a fan, the filter module 10, the heat recovery module 9, the vaporizer module 11, the fan module 14, and the distributor module 12 with at least one integrated heater.

FIG. 6 shows another embodiment of the air conditioner 1 obtained with the invention, the modular assembly 4 of which contains at least the filter module 10, the heat recovery module 9, and the vaporizer module 11. The modules 9, 10, 11, 12, 13, 14 in the modular assembly 4 are directly adjacent to one another, with the heat recovery module 9 upstream of the vaporizer module 11 in the airflow 8. The heat recovery module 9 also contains an exhaust channel 30 for the exhaust air 15. FIG. 7 illustrates another conceivable embodiment of the air conditioner 1 obtained with the invention, in which the modular assembly 4 does not have a heat recovery module 9.

FIG. 8 shows a perspective view of the heat recovery module 9 for the air conditioner 1 obtained with the invention. The heat recovery module 9 in this case is an air-to-air heat exchanger. It can be seen that the path for the exhaust air 15 to be removed from the passenger compartment 7 in the vehicle 2, 3, and that for the airflow 8 are separated within the heat recovery module 9, and cross over one another.

FIG. 9 shows a highly simplified cutaway view of the modular assembly 4 for the air conditioner 1 obtained with the invention, in which the filter module 10, the heat recovery module 9, and the vaporizer module 11 are shown purely by way of example. It can be seen that the modules 9, 10, 11, 12, 13, 14 contain internal channel segments 16, which are combined to form an air channel 17 for the modular assembly 4 in the assembled state, through which a path 18 for the airflow 8 is formed. To be able to adapt the modular assembly 4, or the air conditioner 1, to new vehicle models, the modules 9, 10, 11, 12, 13, 14 each have an intake side 19 and an outlet side 20. There are intake holes 21 for the channel segments 16 on the intake sides 19, and outlet holes 22 for the channel segments 16 on the outlet sides 20, wherein the intake holes 21 and outlet holes 22 of at least two adjacent modules 9, 10, 11, 12, 13,1 4 are identical, or substantially identical.

The intake sides 19 have first mechanical interfaces 23 for connecting the respective modules 9, 10, 11, 12, 13, 14 to adjacent modules 9, 10, 11, 12, 13, 14, and the outlet sides 20 have second mechanical interfaces 24 for connecting the respective modules 9, 10, 11, 12, 13, 14 to adjacent modules 9, 10, 11, 12, 13, 14. The first mechanical interfaces 23 and second mechanical interfaces 24 are complementary, with connecting structures 25 that can be coupled to one another. Purely by way of example, the connecting structures 25 on the first mechanical interfaces 23 are formed by grooves 26, and the connecting structures 25 on the second mechanical interfaces 24 are formed by tongues 27.

FIGS. 10 to 13 show vehicles 2, 3 obtained with the invention, each of which has a passenger compartment 7, a space 33 in the front 34 of the vehicle 2, 3, in particular an engine compartment, and an air conditioner 1 according to any of the preceding embodiments.

In the embodiment shown in FIG. 10, the air conditioner 1 contains a modular assembly 4 with the following modules: the fresh air/recirculated air module 13 with an integrated fan, the filter module 10, the heat recovery module 9, the vaporizer module 11, and the distributor module 12 with at least one integrated heater. FIG. 10 also shows that the air conditioner 1 is placed on a separating wall 35 in the vehicle 2, 3, which separates the space 33 in the front 34 from the passenger compartment 7, and all of the modules 9, 10, 11, 12, 13 of the modular assembly 4 for the air conditioner 1 are inside the passenger compartment 7 in the vehicle 2, 3. Consequently, the space 33, or engine compartment in the front 34 has a relatively large amount of installation space, which may be advantageous, in particular in a vehicle 2 with an internal combustion engine.

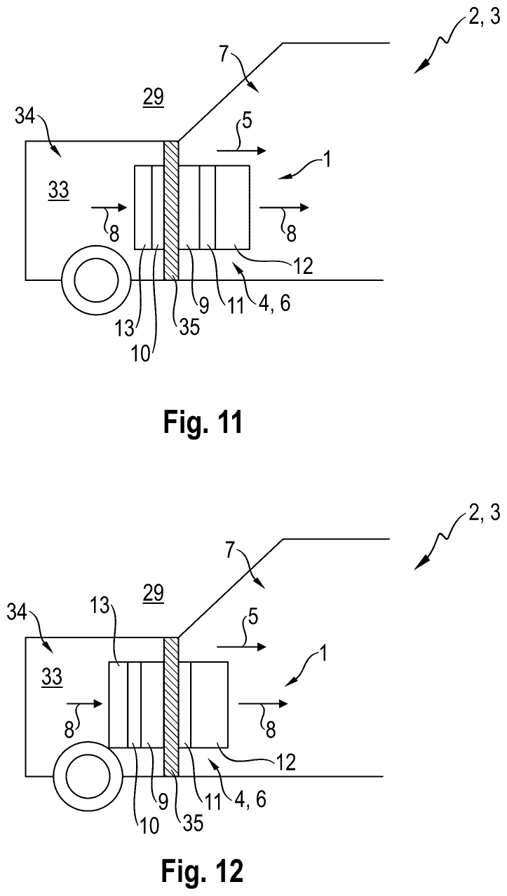

The embodiments of the vehicle 2, 3 shown in FIGS. 11 to 13 differ from the embodiment shown in FIG. 10 in that the modules 9, 10, 11, 12, 13 in the modular assembly 4 for the air conditioner 1 are arranged successively from the passenger compartment 7 into the space 33 in the front 34, to provide more space within the passenger compartment 7.

FIG. 11 shows that the fresh air/recirculated air module 13 with an integrated fan, and the filter module 10 are inside the space 33 in the front 34 of the vehicle 2, 3, in particular the engine compartment, while the heat recovery module 9, the vaporizer module 11, and the distributor module 12 with the integrated heater are inside the passenger compartment 7 in the vehicle 2, 3.

In FIG. 12 the fresh air/recirculated air module 13 with a fan, the filter module 10, and the heat recovery module 9 are inside the space 33 in the front 34 of the vehicle 2, 3, in particular the engine compartment, while the vaporizer module 11 and distributor module 12 with at least one integrated heater are inside the passenger compartment 7 in the vehicle 2, 3.

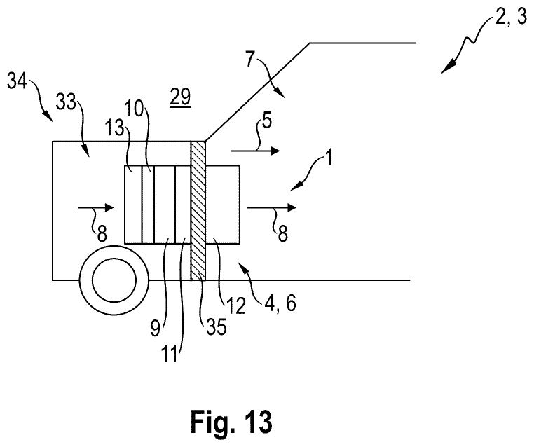

In FIG. 13 the fresh air/recirculated air module 13 with an integrated fan, the filter module 10, the heat recovery module 9, and the vaporizer module 11 are inside the space 33 in the front 34 of the vehicle 2, 3, in particular the engine compartment, while only the distributor module 12 with at least one integrated heater is inside the passenger compartment 7 in the vehicle 2, 3. This results in a relatively large number of modules in the modular assembly 4 inside the space 33 in the front 34 of the vehicle 2, 3, such that there are fewer modules in the passenger compartment, resulting in more space therein.

The specification can be readily understood with reference to the following Numbered Paragraphs:

Numbered Paragraph 1. An air conditioner (1) for a vehicle (2, 3), in particular a vehicle (2) with an internal combustion engine or an electric vehicle (3), which has a modular assembly (4) with numerous conditioning units (6) for an airflow (8) entering the passenger compartment (7) in the vehicle (2, 3), characterized in that the conditioning units (6) are arranged in a sequence (5) and formed by modules (9, 10, 11, 12, 13, 14) that can be mechanically connected directly to one another for fluid exchange.

Numbered Paragraph 2. The air conditioner (1) according to Numbered Paragraph 1, characterized in that one of the modules (9, 10, 11, 12, 13, 14) in the modular assembly (4) is a heat recovery module (9) for transferring heat from an exhaust airflow (15) from the passenger compartment (7) in the vehicle (2, 3) to the airflow (12).

Numbered Paragraph 3. The air conditioner (1) according to Numbered Paragraph 1 or 2, characterized in that
the modules (9, 10, 11, 12, 13, 14) contain internal channel segments (16), which form an air channel (17) in the assembled modular assembly (4), through which a path (18) for the airflow (8) passes, and
the modules (9, 10, 11, 12, 13, 14) each have an intake side (19) with an intake hole (21) for a channel segment (16) in the respective module (9, 10, 11, 12, 13, 14), and an outlet side (20) with an outlet hole (22) for a channel segment (16) in the respective module (9, 10, 11, 12, 13, 14),
wherein the intake holes (21) and outlet holes (22) of adjacent modules (9, 10, 11, 12, 13, 14) are identical, or substantially identical.

Numbered Paragraph 4. The air conditioner (1) according to any of the preceding Numbered Paragraphs, characterized in that
the modules (9, 10, 11, 12, 13, 14) contain internal channel segments (16), which form an air channel (17) in the assembled modular assembly (4), through which a path (18) for the airflow (8) passes, and
the modules (9, 10, 11, 12, 13,14) each have an intake side (19) with a first mechanical interface (23) for connecting the respective module (9, 10, 11, 12, 13, 14) to an adjacent module (9, 10, 11, 12, 13, 14), and an outlet side (20) with a second mechanical interface (24) for connecting the respective module (9, 10, 11, 12, 13, 14) to an adjacent module (9, 10, 11, 12, 13,14),
wherein the first mechanical interfaces (23) and second mechanical interfaces (24) are complementary, with connecting structures (25) that can be coupled to one another.

Numbered Paragraph 5. The air conditioner (1) according to Numbered Paragraph 4, characterized in that the connecting structures (25) on the first mechanical interfaces (23) are grooves, and the connecting structures (25) on the second mechanical interfaces (24) are tongues (27).

Numbered Paragraph 6. The air conditioner (1) according to any of the preceding Numbered Paragraphs, characterized in that the modular assembly (4) contains at least one of the following modules (10, 11, 12, 13,14):
a filter module (10) for filtering the airflow (8),
a vaporizer module (11) for cooling the airflow (8),
a distributor module (12) for distributing the airflow (8) in the passenger compartment (7) in the vehicle (2, 3),
a fresh air/recirculated air module (13) for suctioning off air from the exterior, the passenger compartment (7) in the vehicle (2, 3), or a mixture of fresh air and recirculated air, or
a fan module (14) for conveying the airflow (8).

Numbered Paragraph 7. The air conditioner (1) according to Numbered Paragraph 6 in conjunction with Numbered Paragraph 2, characterized in that the modules (9, 10, 11, 12, 13, 14) in the modular assembly (4) are arranged in one of the following sequences (5):
the fresh air/recirculated air module (13) with an integrated fan, the filter module (10), the heat recovery module (9), the vaporizer module (11), and the distributor module (12) with an integrated heater,
the filter module (10), the fresh air/recirculated air module (13) with an integrated fan, the heat recovery module (9), the vaporizer module (11), and the distributor module (12) with at least one integrated heater,
the fresh air/recirculated air module (13) with an integrated fan, the heat recovery module (9), the filter module (10), the vaporizer module (11), and the distributor module (12) with at least one integrated heater,
a fresh air/recirculated air module (13) without a fan, the fan module (14), the filter module (10), the heat recovery module (9), the vaporizer module (11), and the distributor module (12) with at least one integrated heater, or
the fresh air/recirculated air module (13), the filter module (10), the heat recovery module (9), the vaporizer module (11), the fan module (14), and the distributor module (12) with at least one integrated heater.

Numbered Paragraph 8. A vehicle (2, 3) that has a passenger compartment (7) and an air conditioner (1) according to any of the preceding Numbered Paragraphs 1 to 7, the conditioning units (6) of which are designed to condition an airflow (8) supplied to the passenger compartment (7).

Numbered Paragraph 9. The vehicle (2, 3) according to Numbered Paragraph 8, characterized in that
the heat recovery module (9) in the modular assembly (4) for the air conditioner (1) is inside the passenger compartment (7) in the vehicle (2, 3), or
the heat recovery module (9) in the modular assembly (4) for the air conditioner (1) is inside a space (33) in the front (34) of the vehicle (2, 3).

Numbered Paragraph 10. The vehicle (2, 3) according to Numbered Paragraph 8 or 9, characterized in that
the modular assembly (4) for the air conditioner (1) contains a heat recovery module (9) and a vaporizer module (11),
the vaporizer module (11) contains a condensation discharge channel for removing condensation from the vaporizer (11), and
the heat recovery module (9) contains an exhaust channel (30) for removing exhaust air (15) from the air in the passenger compartment (7) in the vehicle (2, 3).

Numbered Paragraph 11. The vehicle (2, 3) according to Numbered Paragraph 10, characterized in that the condensation channel and the exhaust channel (30) are joined, at least in part, to form a single discharge channel for the condensation from the vaporizer module (11) and the exhaust air (15) from the heat recovery module (9).

Numbered Paragraph 12. The vehicle (2, 3) according to Numbered Paragraph 11, characterized in that
the discharge channel has two separate ducts, the first of which is for condensation, and the second is for exhaust air (15), or
the discharge channel has a single duct, which is for both the condensation and the exhaust air (15).

Numbered Paragraph 13. The vehicle (2, 3) according to any of the Numbered Paragraphs 10 to 12, characterized in that the condensation channel and the exhaust channel (30) are at least partially separated, or form separate channels.

### LIST OF REFERENCE SYMBOLS

1 air conditioner
2 vehicle with an internal combustion engine
3 electric vehicle
4 modular assembly
5 sequence
6 conditioning units
7 passenger compartment
8 airflow
9 heat recovery module
10 filter module
11 vaporizer module
12 distributor module
13 fresh air/recirculated air module
14 fan module
15 exhaust air
16 channel segment
17 air channel
18 path
19 intake side
20 outlet side
21 intake hole
22 outlet hole
23 first mechanical interface
24 second mechanical interface
25 connecting contour
26 groove
27 tongue
29 exterior
30 exhaust channel
33 space
34 front part
35 separating wall
1-13. (canceled)

14. An air conditioner for a vehicle, in particular a vehicle with an internal combustion engine or an electric vehicle, comprising a modular assembly with numerous conditioning units for an airflow entering the passenger compartment in the vehicle, wherein the conditioning units are arranged in a sequence and formed by a plurality of modules that can be mechanically connected directly to one another for fluid exchange.

15. The air conditioner according to claim 14, wherein one of the plurality of modules in the modular assembly is a heat recovery module for transferring heat from an exhaust airflow from the passenger compartment in the vehicle to the airflow.

16. The air conditioner according to claim 14, wherein
The plurality of modules each contain internal channel segments, which form an air channel in the assembled modular assembly, through which a path for the airflow passes, and
the plurality of modules each have an intake side with an intake hole for a channel segment in the respective module, and an outlet side with an outlet hole for a channel segment in the respective module,
wherein the intake holes and outlet holes of adjacent modules are identical, or substantially identical.

17. The air conditioner according to claim 14, wherein The plurality of modules comprise internal channel segments, which form an air channel in the assembled modular assembly, through which a path for the airflow passes, and
the plurality of modules each comprise an intake side with a first mechanical interface configured for connecting the respective module of the plurality of modules to an adjacent module, and an outlet side with a second mechanical interface configured for connecting the respective module to an adjacent module,
wherein the first mechanical interfaces and second mechanical interfaces are complementary, with connecting structures that are configured to be coupled to one another.

18. The air conditioner according to claim 17, wherein the connecting structures on the first mechanical interfaces are grooves, and the connecting structures on the second mechanical interfaces are tongues.

19. The air conditioner according to claim 14, wherein the modular assembly comprises at least one of the following types modules that are one or more of the plurality of modules:
a filter module configured for filtering the airflow,
a vaporizer module configured for cooling the airflow,
a distributor module configured for distributing the airflow in the passenger compartment in the vehicle,
a fresh air/recirculated air module configured for suctioning off air from the exterior, the passenger compartment in the vehicle, or a mixture of fresh air and recirculated air, or
a fan module configured for conveying the airflow.

20. The air conditioner according to claim 19, wherein
one of the plurality of modules in the modular assembly is a heat recovery module for transferring heat from an exhaust airflow from the passenger compartment in the vehicle to the airflow, and
wherein the plurality of modules in the modular assembly are arranged in one of the following sequences:
the fresh air/recirculated air module with an integrated fan, the filter module, the heat recovery module, the vaporizer module, and the distributor module with an integrated heater,
the filter module, the fresh air/recirculated air module with an integrated fan, the heat recovery module, the vaporizer module, and the distributor module with at least one integrated heater,
the fresh air/recirculated air module with an integrated fan, the heat recovery module, the filter module, the vaporizer module, and the distributor module with at least one integrated heater,
a fresh air/recirculated air module without a fan, the fan module, the filter module, the heat recovery module, the vaporizer module, and the distributor module with at least one integrated heater, or
the fresh air/recirculated air module, the filter module, the heat recovery module, the vaporizer module, the fan module, and the distributor module with at least one integrated heater.

21. A vehicle comprising a passenger compartment and an air conditioner according to claim 14, the air conditioning units of which are configured to condition an airflow supplied to the passenger compartment.

22. The vehicle according to claim 21, wherein
the heat recovery module in the modular assembly for the air conditioner is inside the passenger compartment in the vehicle, or
the heat recovery module in the modular assembly for the air conditioner is inside a space in the front of the vehicle.

23. The vehicle according to claim 21, wherein
the modular assembly for the air conditioner comprises a heat recovery module and a vaporizer module,
the vaporizer module comprises a condensation discharge channel for removing condensation from the vaporizer, and
the heat recovery module comprises an exhaust channel for removing exhaust air from the air in the passenger compartment in the vehicle.

24. The vehicle according to claim 23, wherein the condensation channel and the exhaust channel are joined, at least in part, to form a single discharge channel for the condensation from the vaporizer module and the exhaust air from the heat recovery module.

25. The vehicle according to claim 24, wherein
the discharge channel has two separate ducts, the first of which is for condensation, and the second of which is for exhaust air, or
the discharge channel has a single duct, which is for both the condensation and the exhaust air.

26. The vehicle according to claim 23, wherein the condensation channel and the exhaust channel are at least partially separated.

27. The vehicle according to claim 23, wherein the condensation channel and the exhaust channel form separate channels.
